(19) United States
(12) Patent Application Publication
(10) Pub. No.: US 2017/0244939 A1
(43) Pub. Date: Aug. 24, 2017

(54) WAVELENGTH CONVERSION DEVICE, ILLUMINATION DEVICE, AND PROJECTOR

(71) Applicant: Seiko Epson Corporation, Tokyo (JP)

(72) Inventor: Osamu Arakawa, Shirojiri-shi (JP)

(21) Appl. No.: 15/429,134

(22) Filed: Feb. 9, 2017

(30) Foreign Application Priority Data
Feb. 23, 2016 (JP) 2016-032066

(51) Int. Cl. H04N 9/31; G02B 26/00; G03B 21/20; F21V 29/502

(52) U.S. Cl. CPC H04N 9/3144; F21V 29/502; G02B 26/008; H04N 9/3114; G03B 21/204

(57) ABSTRACT

A wavelength conversion device according to an aspect of the invention includes a rotary device having a rotary part rotating around an axis, a base member rotated around the axis by the rotary device, an inorganic wavelength conversion element provided to the base member, and a heat radiation member fixed to the base member, the heat radiation member has a ring-like shape surrounding the axis, and spreads outward in a radial direction of the axis beyond the base member, and the heat radiation member and the base member are formed separately from each other.

### CROSS-REFERENCE TO RELATED APPLICATION

The entire disclosure of Japanese Patent Application No. 2016-032066, filed Feb. 23, 2016 is expressly incorporated by reference herein.

### BACKGROUND

1. Technical Field

The present invention relates to a wavelength conversion device, an illumination device, and a projector.

2. Related Art

There has been known a light emitting wheel, which has a phosphor layer for emitting light in a predetermined wavelength band in response to light received, and is driven rotationally (see, e.g., JP-A-2010-256457).

In such a light emitting wheel as described above, warpage is caused in a circular substrate, on which the phosphor layer is disposed, in some cases. The warpage of the circular substrate is caused in, for example, a mill-roll direction in the case in which the circular substrate is manufactured using a rolled material. In the case of a configuration in which the phosphor layer has a binder made of an inorganic material, if the warpage is caused in the circular substrate, stress is applied to the phosphor layer, and there is a problem that the phosphor layer is broken and damaged.

To cope with this problem, by, for example, increasing the thickness of the circular substrate, it is possible to prevent the warpage from being caused in the circular substrate. However, in such a case, the weight of the circular substrate increases, and there is a problem that the rotary device for rotating the circular substrate grows in size. For example, if the outside diameter of the circular substrate is made smaller, the weight of the circular substrate can be reduced. However, in such a case, the surface area of the circular substrate decreases, and it becomes difficult to radiate the heat of the phosphor layer from the circular substrate. Therefore, there is a problem that the phosphor layer becomes high in temperature to deteriorate.

### SUMMARY

An advantage of some aspects of the invention is to provide a wavelength conversion device capable of inhibiting an inorganic wavelength conversion element from being deteriorated and damaged while preventing the rotary device from growing in size, an illumination device equipped with such a wavelength conversion device, and a projector equipped with such an illumination device.

A wavelength conversion device according to an aspect of the invention includes a rotary device having a rotary part rotating around an axis, a base member rotated around the axis by the rotary device, an inorganic wavelength conversion element provided to the base member, and a heat radiation member fixed to the base member, the heat radiation member has a ring-like shape surrounding the axis, and spreads outward in a radial direction of the axis beyond the base member, and the heat radiation member and the base member are formed separately from each other.

According to the wavelength conversion device related to the aspect of the invention, the base member and the heat radiation member are disposed separately from each other instead of a circular substrate. Therefore, by manufacturing the base member so that the dimension in the axial direction becomes relatively large, it is possible to prevent the warpage from being caused in the base member. Thus, it is possible to prevent the inorganic wavelength conversion element disposed on the base member from being damaged by the warpage of the base member.

Further, since the heat radiation member is disposed, even if the outside diameter of the base member is decreased, it is easy to release the heat of the inorganic wavelength conversion element via the heat radiation member. Thus, it is possible to prevent the inorganic wavelength conversion element from becoming high in temperature to be deteriorated, while reducing the weight of the base member, which makes the axial dimension relatively large. In addition, since no stress is applied to the inorganic wavelength conversion element depending on the warpage of the heat radiation member, the axial dimension of the heat radiation member can be reduced. Thus, it is possible to reduce the weight of a connected body of the base member and the heat radiation member rotated by the rotary device. As described hereinabove, according to the present aspect of the invention, it is possible to prevent the inorganic wavelength conversion element from being deteriorated and damaged while preventing the rotary device from growing in size.

A dimension in a direction of the axis of the base member may be larger than a dimension in the direction of the axis of the heat radiation member.

According to this configuration, since it is possible to make the dimension in the axial direction of the base member relatively large, it is possible to prevent the warpage from being caused in the base member.

In a case of being viewed along the direction of the axis, the base member and the heat radiation member may partially overlap each other.

According to this configuration, since the contact area between the base member and the heat radiation member can be made larger, it is easy to transfer the heat of the inorganic wavelength conversion element from the base member to the heat radiation member to radiate the heat. Further, it is easy to stably fix the base member and the heat radiation member to each other.

The base member may be provided with a hole formed along the direction of the axis.

According to this configuration, the weight of the base member can further be reduced.

An illumination device according to an aspect of the invention includes a light source, and the wavelength conversion device described above, in which light emitted from the light source enters the wavelength conversion device, and the wavelength conversion device performs wavelength conversion on the light having entered the wavelength conversion device using the inorganic wavelength conversion element, and emits the light, on which the wavelength conversion has been performed, on a same side as a side which the light has entered.

According to the illumination device related to the aspect of the invention, since the wavelength conversion device described above is provided, it is possible to prevent the inorganic wavelength conversion element from being deteriorated and damaged while preventing the rotary device from growing in size.

A projector according to an aspect of the invention includes the illumination device described above, a light modulation device adapted to modulate illumination light from the illumination device in accordance with image information to thereby form image light, and a projection optical system adapted to project the image light.

According to the projector related to the aspect of the invention, since the illumination device described above is provided, it is possible to prevent the inorganic wavelength conversion element from being deteriorated and damaged while preventing the rotary device from growing in size.

### BRIEF DESCRIPTION OF THE DRAWINGS

The invention will be described with reference to the accompanying drawings, wherein like numbers reference like elements.

FIG. 1 is a schematic configuration diagram showing a projector according to a first embodiment of the invention.

FIG. 2 is a cross-sectional view showing a region of the wavelength conversion device according to the first embodiment.

FIG. 3 is a plan view showing the wavelength conversion device according to the first embodiment.

FIG. 4 is a cross-sectional view showing a region of the wavelength conversion device according to a second embodiment of the invention.

FIG. 5 is a diagram for explaining a warpage of a circular disk.

### DESCRIPTION OF EXEMPLARY EMBODIMENTS

Hereinafter, a projector according to an embodiment of the invention will be described with reference to the accompanying drawings. It should be noted that the scope of the invention is not limited to the embodiments hereinafter described, but can arbitrarily be modified within the technical idea or the technical concept of the invention. Further, in the following drawings, the actual structures and the structures of the drawings are made different from each other in scale size, number, and so on in some cases in order to make each constituent easy to understand.

### First Embodiment

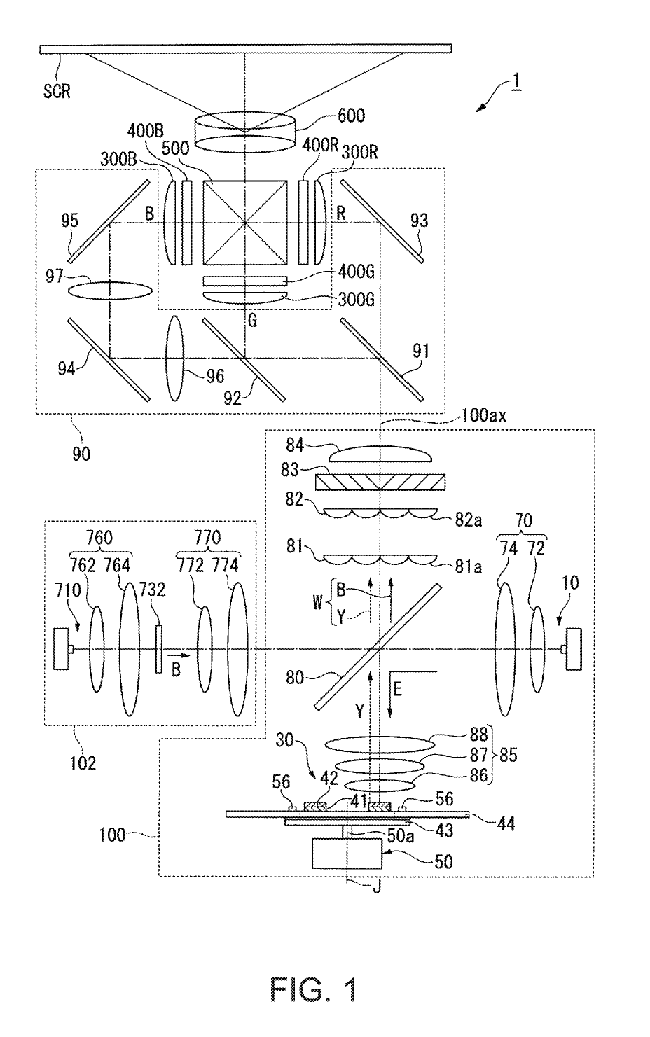

FIG. 1 is a schematic configuration diagram showing a projector 1 according to the present embodiment. The projector 1 shown in FIG. 1 is a projection-type image display device for displaying a color picture on a screen SCR. As shown in FIG. 1, the projector 1 is provided with a first illumination device (an illumination device) 100, a second illumination device 102, a color separation light guide optical system 90, three liquid crystal light modulation devices 400R, 400G, and 400B (light modulation devices), a cross dichroic prism 500, and a projection optical system 600.

The first illumination device 100 is provided with a first light source (a light source) 10, a collimating optical system 70, a dichroic mirror 80, a collimating light collection optical system 85, a wavelength conversion device 30, a first lens array 81, a second lens array 82, a polarization conversion element 83, and an overlapping lens 84.

As the first light source 10, there can be used a semiconductor laser (a light emitting element) for emitting blue light (having a peak emission intensity at a wavelength of about 445 nm) E in a first wavelength band as excitation light. The first light source 10 can also be a single semiconductor laser, or can also be formed of a plurality of semiconductor lasers.

It should be noted that it is also possible to use a semiconductor laser for emitting the blue light having a wavelength (e.g., 460 nm) other than 445 nm as the first light source 10.

In the present embodiment, the first light source 10 is arranged so as to have an optical axis crossing an illumination light axis 100ax.

The collimating optical system 70 is provided with a first lens 72 and a second lens 74, and roughly collimates the light from the first light source 10. The first lens 72 and the second lens 74 are each formed of a convex lens.

The dichroic mirror 80 is disposed in a light path from the collimating optical system 70 to the collimating light collection optical system 85 so as to cross each of the optical axis of the first light source 10 and the illumination light axis 100ax at an angle of 45°. The dichroic mirror 80 reflects the blue light, and transmits yellow fluorescence including red light and green light.

The collimating light collection optical system 85 has a function of making the blue light from the dichroic mirror 80 enter the wavelength conversion device 30 in a roughly focused state, and a function of roughly collimating the fluorescence emitted from the wavelength conversion device 30. The collimating light collection optical system 85 is provided with a first lens 86, a second lens 87, and a third lens 88. The first lens 86, the second lens 87, and the third lens 88 are each formed of a convex lens.

The wavelength conversion device 30 is a reflective-type wavelength conversion device. The blue light E in a first wavelength band emitted from the first light source enters the wavelength conversion device 30 via the collimating light collection optical system 85. The wavelength conversion device 30 performs wavelength conversion on the blue light E having entered the wavelength conversion device 30 using a phosphor layer 42 described later, and then emits the result toward the same side as the incident side, which the blue light E has entered, as fluorescence Y in a second wavelength band.

The fluorescence Y is the light including the red light and the green light. The fluorescence Y having been emitted from the wavelength conversion device 30 enters the collimating light collection optical system 85. The wavelength conversion device 30 will be described in detail in the latter part.

The second illumination device 102 is provided with a second light source device 710, a light collection optical system 760, a scattering plate 732, and a collimating optical system 770.

The second light source 710 is constituted by, for example, the same semiconductor laser as the first light source 10 of the first illumination device 100.

The light collection optical system 760 is provided with a first lens 762 and a second lens 764. The light collection optical system 760 collects the blue light from the second light source 710 in the vicinity of the scattering plate 732. The first lens 762 and the second lens 764 are each formed of a convex lens.

The scattering plate 732 scatters blue light B from the second light source 710 to thereby form the blue light B having a light distribution similar to the light distribution of the fluorescence Y emitted from the wavelength conversion device 30. As the scattering plate 732, there can be used, for example, frosted glass made of optical glass.

The collimating optical system 770 is provided with a first lens 772 and a second lens 774, and roughly collimates the light from the scattering plate 732. The first lens 772 and the second lens 774 are each formed of a convex lens.

In the present embodiment, the blue light B from the second illumination device 102 is reflected by the dichroic mirror 80, then combined with the fluorescence Y, which has been emitted from the wavelength conversion device 30 and then transmitted through the dichroic mirror 80, and then turns to white light W. The white light W enters the first lens array 81.

The first lens array 81 has a plurality of first small lenses 81a for dividing the light from the dichroic mirror 80 into a plurality of partial light beams. The plurality of first small lenses 81a is arranged in a matrix in a plane crossing the illumination optical axis 100ax.

The second lens array 82 has a plurality of second small lenses 82a corresponding to the plurality of first small lenses 81a of the first lens array 81. The second lens array 82 images the image of each of the first small lenses 81a of the first lens array 81 in the vicinity of each of the image forming areas of the liquid crystal light modulation devices 400R, 400G, and 400B in cooperation with the overlapping lens 84. The plurality of second small lenses 82a is arranged in a matrix in a plane crossing the illumination optical axis 100ax.

The polarization conversion element 83 converts each of the partial light beams, which are divided into by the first lens array 81, into a linearly polarized light beam. The polarization conversion element 83 has a polarization separation layer, a reflecting layer, and a wave plate. The polarization separation layer transmits one linearly polarized component without modification and reflects the other linearly polarized component toward the reflecting layer out of the polarization components included in the light from the wavelength conversion device 30. The reflecting layer reflects the other linearly polarized component, which has been reflected by the polarization separation layer, in a direction parallel to the illumination light axis 100ax. The wave plate converts the other linearly polarized component having been reflected by the reflecting layer into the one linearly polarized component.

The overlapping lens 84 collects each of the partial light beams from the polarization conversion element 83 to make the partial light beams overlap each other in the vicinity of each of the image forming areas of the liquid crystal light modulation devices 400R, 400G, and 400B. The first lens array 81, the second lens array 82, and the overlapping lens 84 constitute an integrator optical system for homogenizing the in-plane light intensity distribution of the light from the wavelength conversion device 30.

The color separation light guide optical system 90 is provided with dichroic mirrors 91, 92, reflecting mirrors 93, 94, and 95, and relay lenses 96, 97. The color separation light guide optical system 90 separates the white light W from the first illumination device 100 and the second illumination device 102 into the red light R, the green light G, and the blue light B, and then guides the red light R, the green light G, and the blue light B to the corresponding liquid crystal light modulation devices 400R, 400G, and 400B, respectively.

Between the color separation light guide optical system 90 and the liquid crystal light modulation devices 400R, 400G, and 400B, there are disposed field lenses 300R, 300G, and 300B, respectively.

The dichroic mirror 91 is a dichroic mirror for transmitting the red light component and reflecting the green light component and the blue light component.

The dichroic mirror 92 is a dichroic mirror for reflecting the green light component and transmitting the blue light component.

The reflecting mirror 93 is a reflecting mirror for reflecting the red light component.

The reflecting mirrors 94, 95 are reflecting mirrors for reflecting the blue light component.

The red light having passed through the dichroic mirror 91 is reflected by the reflecting mirror 93, and then enters the image forming area of the liquid crystal light modulation device 400R for the red light after passing through the field lens 300R.

The green light having been reflected by the dichroic mirror 91 is further reflected by the dichroic mirror 92, and then enters the image forming area of the liquid crystal light modulation device 400G for the green light after passing through the field lens 300G.

The blue light having passed through the dichroic mirror 92 enters the image forming area of the liquid crystal light modulation device 400B for the blue light via the relay lens 96, the reflecting mirror 94 on the incident side, the relay lens 97, the reflecting mirror 95 on the exit side, and the field lens 300B.

The liquid crystal light modulation devices 400R, 400G, and 400B modulate the illumination light from the first illumination device 100, which has entered the liquid crystal light modulation devices 400R, 400G, and 400B via the color separation light guide optical system 90, in accordance with the image information to thereby form the image light. The liquid crystal modulation devices 400R, 400G, and 400B each form the image light corresponding to the colored light having entered the liquid crystal light modulation device. It should be noted that, although not shown in the drawings, incident side polarization plates are disposed between the field lenses 300R, 300G, and 300B and the liquid crystal light modulation devices 400R, 400G, and 400B, respectively, and exit side polarization plates are disposed between the liquid crystal light modulation devices 400R, 400G, and 400B and the cross dichroic prism 500, respectively.

The cross dichroic prism 500 is an optical element for combining the image light emitted from the respective liquid crystal light modulation devices 400R, 400G, and 400B with each other to form the color image.

The cross dichroic prism 500 has a roughly rectangular planar shape composed of four rectangular prisms bonded to each other, and on the roughly X-shaped interfaces on which the rectangular prisms are bonded to each other, there are formed dielectric multilayer films.

The color image having been emitted from the cross dichroic prism 500 enters the projection optical system 600. The projection optical system 600 projects the color image (the image light) having entered the projection optical system 600 toward the screen SCR in an enlarged manner. Thus, the image is formed on the screen SCR.

Then, the wavelength conversion device 30 will be described in detail.

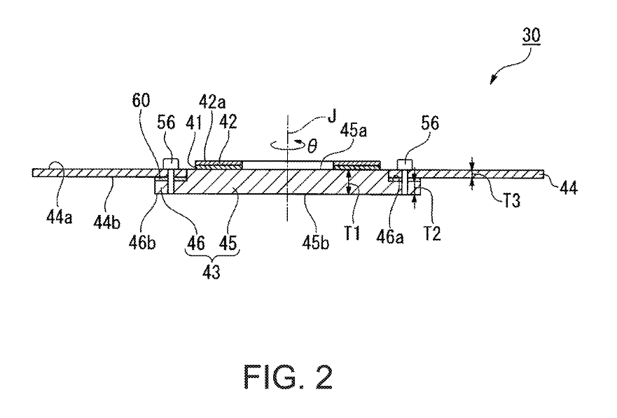

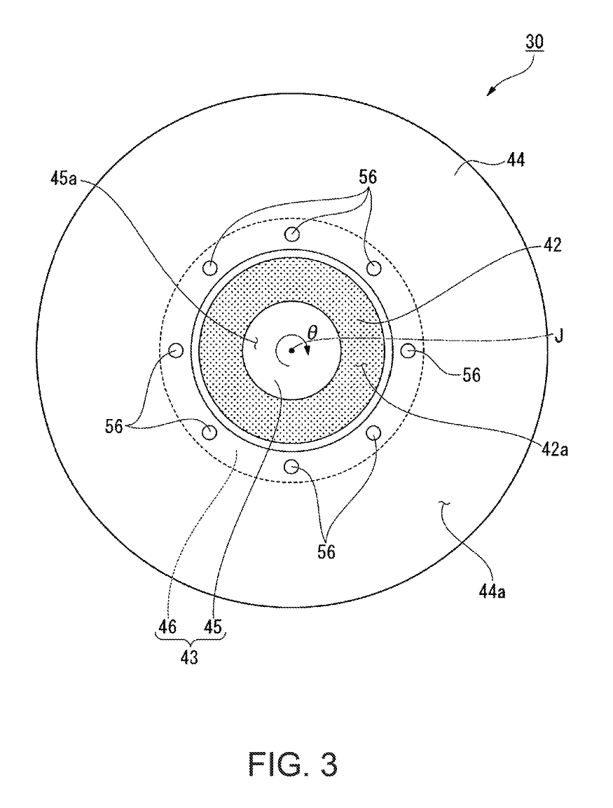

FIG. 2 is a cross-sectional view showing a region of the wavelength conversion device 30. FIG. 3 is a plan view showing the wavelength conversion device 30. In FIG. 2, an electric motor 50 is omitted from the drawing.

As shown in FIG. 1 and FIG. 2, the wavelength conversion device 30 is provided with the electric motor (a rotary device) 50, a base member 43, a reflecting film 41, the phosphor layer (an inorganic wavelength conversion element) 42, and a heat radiation member 44. The electric motor 50 shown in FIG. 1 is, for example, an inner-rotor motor. The electric motor 50 has a shaft (a rotary part) 50a rotating around a central axis (a predetermined axis) J.

In the following description, a direction parallel to the central axis J is simply called an “axial direction (predetermined axis direction)” in some cases, and a radial direction centered on the central axis J is simply called a “redial direction” in some cases, and a circumferential direction (θ direction) centered on the central axis J is simply called a “circumferential direction” in some cases. Further, in the relative relationship in the axial direction between the base member 43 and the electric motor 50, the base member 43 side is defined as an “upper side” in the axial direction, and the electric motor 50 side is defined as a “lower side” in the axial direction. It should be noted that the “upper side” and the “lower side” are expressions used simply for the explanation, and do not limit the actual positional relationship, usage configurations, and so on.

The base member 43 is fixed to the shaft 50a of the electric motor 50. Thus, the base member 43 rotated around (±θ directions) the central axis J by the electric motor 50. As shown in FIG. 2 and FIG. 3, the base member 43 has, for example, a disk-like shape, the center of which the central axis J passes through. The base member 43 has a base member main body 45 and a flange part 46. The base member 45 is a part to be provided with the phosphor layer 42. The base member 45 has a disk-like shape, the center of which the central axis J passes through.

As shown in FIG. 2, the flange part 46 extends from a lower end of the periphery of the base member main body 45 outward in the radial direction. As shown in FIG. 3, the flange part 46 has an annular shape centered on the central axis J.

As shown in FIG. 2, the dimension T2 in the axial direction of the flange part 46 is smaller than the dimension T1 in the axial direction of the base member main body 45. The lower surface 46b of the flange part 46 and the lower surface 45b of the base member main body 45 are coplanar with each other. Since the flange part 46 is disposed, the outer edge in the radial direction on the upper surface of the base member 43 is provided with a step, which is recessed downward, formed in a direction from the inside in the radial direction toward the outside in the radial direction.

The dimensions in the axial direction of the base member 43, namely the dimension T1 in the axial direction of the base member main body 45 and the dimension T2 in the axial direction of the flange part 46, are larger than a dimension T3 in the axial direction of the heat radiation member 44. As an example, the dimension T1 in the axial direction of the base member 45 is equal to or larger than 3 mm. By determining the dimension T1 in the axial direction of the base member main body 45 as described above, the warpage can preferably be prevented from being caused in the base member main body 45.

In the present embodiment, the base member 43 is a single member. The base member is made of, for example, metal relatively high in thermal conductivity. The material of the base member 43 is, for example, copper, aluminum, or iron. The base member 43 is manufactured by, for example, cutting.

The reflecting film 41 is disposed on the base member 43. In more detail, the reflecting film 41 is disposed on the upper surface 45a of the base member main body 45 among the upper surface of the base member 43. The reflecting film 41 is located between the phosphor layer 42 and the base member 43 in the axial direction. The reflecting film 41 is designed to reflect the fluorescence Y (see FIG. 1), which has been excited by the phosphor layer 42, at high efficiency. The reflecting film 41 is made of a film made of, for example, silver higher in reflectivity than at least than the base member 43. Although not shown in the drawings, the reflecting film 41 has an annular shape centered on the central axis J. The reflecting film 41 is deposited using, for example, a sputtering method or an evaporation method.

As shown in FIG. 3, the phosphor layer 42 has a ring-like shape surrounding the central axis J. In more detail, the phosphor layer 42 has an annular shape, the center of which the central axis J passes through. The phosphor layer 42 is disposed on the base member 43. The phosphor layer 42 is bonded to the base member 43 via, for example, a thermosetting adhesive. In more detail, the phosphor layer 42 is bonded to the base member main body 45 via the reflecting film 41. The thermosetting adhesive for bonding the phosphor layer 42 has a light transmissive property sufficient to transmit the fluorescence Y emitted from the phosphor layer 42. The thermosetting adhesive is, for example, a silicone-type adhesive.

The phosphor layer 42 includes a phosphor and a binder for holding the phosphor. The phosphor included in the phosphor layer 42 is excited by the blue light E in the first wavelength band from the first light source 10, and emits the fluorescence Y in the second wavelength band. The phosphor is, for example, a YAG (yttrium aluminum garnet)-based phosphor having a composition expressed as (Y, Gd)₃(Al, Ga)₅O₁₂:Ce. The binder is, for example, ceramics obtained by sintering an inorganic material such as alumina, or glass. The phosphor layer 42 is formed of phosphor particles dispersed in the binder.

In the present embodiment, the blue light E enters the phosphor layer 42 from the upper surface 42a on the opposite side to the electric motor 50. The blue light E having entered the phosphor layer 42 is converted by the phosphor particles in the fluorescence Y, and is then reflected by the reflecting film 41 toward the upper surface 42a of the phosphor layer 42. Then, the fluorescence Y is emitted from the upper surface 42a of the phosphor layer 42. In other words, in the present embodiment, the upper surface 42a of the phosphor layer 42 is a surface which the blue light E enters, and at the same time, a surface from which the fluorescence Y is emitted.

Although not shown in the drawings, on the upper surface 42a of the phosphor layer 42, there is formed an antireflection film. The material of the antireflection film is a substance relatively low in reflectance with respect to the blue light E as the excitation light for the phosphor layer 42. The material of the antireflection film is, for example, SiO₂. The antireflection film can be a single layer film, or can also be a multilayer film. It should be noted that the antireflection film is not required to be formed.

As shown in FIG. 2 and FIG. 3, the heat radiation member 44 has a ring-like shape surrounding the central axis J. In more detail, the heat radiation member 44 has an annular shape, the center of which the central axis J passes through. The heat radiation member 44 is fitted to the outer circumferential surface of the base member main body 45. The heat radiation member 44 extends from the outer circumferential surface of the base member main body 45 outward in the radial direction, and spreads outward in the radial direction beyond the base member 43 (the flange part 46). The upper surface 44a of the heat radiation member 44 is coplanar with, for example, the upper surface 45a of the base member main body 45.

The inner edge part of the heat radiation member 44 overlaps the flange part 46 in the axial direction. In other words, in the present embodiment, as shown in FIG. 3, the base member 43 and the head radiation member 44 partially overlap each other in the case of being viewed along the axial direction. As shown in FIG. 2, the inner edge part in the lower surface 44b of the head radiation member 44 has contact with the upper surface 46a of the flange part 46 via thermal grease 60. The thermal grease 60 is grease mixed with particles relatively high in thermal conductivity made of metal, ceramic, or the like.

The heat radiation member 44 and the flange part 46 are fixed to each other with a plurality of screws 56. The screws 56 penetrate the heat radiation member 44 and the thermal grease 60 in the axial direction from the upper surface 44a side of the heat radiation member 44, and are screwed into screw holes provided to the flange part 46. Thus, the heat radiation member 44 is fixed to the base member 43. A shown in FIG. 3, there are disposed, for example, eight screws as the screws 56. The eight screws 56 are arranged at regular intervals along the circumferential direction.

The heat radiation member 44 and the base member 43 are formed separately from each other. The heat radiation member 44 is made of, for example, metal. The material of the heat radiation member 44 is a material relatively high in thermal conductivity such as copper or aluminum. The material of the head radiation member can also be the same as the material of the base member 43, or can also be different therefrom. The heat radiation member 44 is manufactured by, for example, being punched out from a rolled material using press work.

In the wavelength conversion device 30, the electric motor 50 rotates the base member 43 around the central axis J (in the θ direction) via the shaft 50a. When the blue light E as the laser beam enters the phosphor layer 42 via the collimating light collection optical system 85, the heat is generated in the phosphor layer 42. The electric motor 50 rotates the base member 43 to thereby sequentially change the incident position of the blue light E in the phosphor layer 42. Thus, such a problem that the same part of the phosphor layer 42 is intensively irradiated with the blue light E to thereby be deteriorated can be prevented from occurring.

The case in which the phosphor layer is provided to a circular disk as in the related art will be considered. FIG. 5 is a diagram for explaining a warpage of the circular disk to be provided with the phosphor layer. As shown in FIG. 5, in the case in which, for example, a circular disk 240 is manufactured by being punched out from the rolled material, the circular disk 240 warps in a direction (a vertical direction in FIG. 5), which crosses the principal surfaces (an upper surface 240a and an lower surface 240b) of the circular disk 240 and crosses the rolling direction (a horizontal direction in FIG. 5) along which the rolled material is rolled, with respect to the rolling direction. In FIG. 5, both of the right and left ends of the circular disk 240 warp upward.

The warpage of the circular disk 240 differs by the radial position. The warpage of the circular disk 240 at a certain radial position is evaluated by a deformation amount in the warpage direction at the certain radial position with respect to the diameter at the certain radial position. Specifically, the warpage of the circular disk 240 at a place where the outer circumferential edge of the phosphor layer 242 is located is evaluated by the deformation amount D of the circular disk 240 with respect to the outside diameter L of the phosphor layer 242 (i.e., D/L).

Here, the deformation amount D is defined as, for example, the deformation amount in the warpage direction (a vertical direction in FIG. 5) of the upper surface 240a of the circular disk 240 in the place where the outer circumferential edge of the phosphor layer 242 is located with reference to the position of the upper surface 240a of the circular disk 240 at the center in the rolling direction (a horizontal direction in FIG. 5). As an example, it is preferable to set the warpage D/L of the circular disk 240 to be equal to or smaller than 0.001. It should be noted that the warpage of the circular disk 240 is caused by other factors than the factor that the circular disk 240 is manufactured from the rolled material in some cases.

If the warpage of the circular disk 240 is large in the place where the phosphor layer 242 is disposed, the stress is apt to significantly be applied to the phosphor layer 242, and in some cases, the phosphor layer 242 is broken to be damaged when assembling the wavelength conversion device, or when rotating the circular disk 240.

To cope with the above, it is also possible to adopt a method of increasing the axial dimension of the circular disk 240 to thereby make it difficult to cause the warpage. However, in this case, the weight of the circular disk 240 increases. Therefore, the torque necessary to rotate the circular disk 240 increases, and the electric motor for rotating the circular disk 240 grows in size in some cases. Further, the inertia moment of the circular disk 240 increases, and it becomes difficult to rotate the circular disk 240 in some cases.

In contrast, if the outside diameter of the circular disk 240 is decreased, it is possible to prevent the weight of the circular disk 240 from increasing even if the axial dimension of the circular disk 240 is increased. However, in this case, the surface area of the circular disk 240 decreases, and the heat radiation performance of the circular disk 240 degrades. Therefore, the heat of the phosphor layer 242 cannot sufficiently be radiated, and the phosphor layer 242 becomes high in temperature to be deteriorated in some cases.

To cope with the problems described above, according to the present embodiment, instead of the circular disk 240, there are provided the base member 43 provided with the phosphor layer 42, and the heat radiation member 44 as a separate member from the base member 43 and fixed to the base member 43. Therefore, by manufacturing the base member 43 so as to have a relatively large axial dimension, it is possible to prevent the warpage from being caused in the base material 43, and it is possible to prevent the phosphor layer 42 disposed on the base member 43 from being damaged.

Further, due to the heat radiation member 44 spreading outward in the radial direction beyond the base member 43, the surface area of a connected body of the base member 43 and the heat radiation member 44 can be increased. Therefore, even if the outside diameter of the base member is decreased, it is easy to sufficiently release the heat from the phosphor layer 42. Thus, it is possible to prevent the phosphor layer 42 from becoming high in temperature to be deteriorated, while decreasing the outside diameter of the base member 43, which makes the axial dimension relatively large, to achieve weight reduction.

In addition, since the phosphor layer 42 is not provided to the heat radiation member 44, even if the warpage is caused in the heat radiation member 44, no stress is applied to the phosphor layer 42 due to the warpage of the heat radiation member 44. Therefore, it is possible to manufacture the heat radiation member 44, which is a separate member from the base member 43, so as to have a relatively small axial dimension. Thus, the connected body of the base member 43 and the heat radiation member 44 can be reduced in weight. Therefore, it is easy to miniaturize the electric motor 50, and it is easy to rotate the base member 43 and the heat radiation member 44. Further, the drive power of the electric motor 50 can be reduced, and the reduction of the power consumption of the electric motor 50 can be achieved.

As described hereinabove, according to the present embodiment, it is possible to prevent the phosphor layer 42 from being deteriorated and damaged while preventing the electric motor 50 from growing in size.

Further, it is preferable for the place where the phosphor layer 42 is disposed to be formed evenly with high accuracy. Here, there is considered the case in which, for example, the base member and the heat radiation member are manufactured as a single member. In this case, in order to form the place where the phosphor layer 42 is disposed evenly with high accuracy, it is necessary to, for example, manufacture the whole of the single member, which is constituted by the base member and the heat radiation member, using cutting work, or perform additional work on the single member having manufactured by casting. Therefore, time and effort for manufacturing the single member, and the manufacturing cost thereof increase in some cases.

In contrast, according to the present embodiment, since the base member 43 and the heat radiation member 44 are formed separately from each other, the manufacturing methods different in formation accuracy can be adopted respectively for the base member 43 and the heat radiation member 44. Thus, it is possible to decrease the size of the member (the base member 43) necessary to be manufactured with high accuracy, and it is possible to reduce the time and effort for manufacturing the base member 43 and the heat radiation member 44 and the manufacturing cost thereof. Specifically, for example, by accurately manufacturing only the base member 43 by the cutting work, the place where the phosphor layer 42 is disposed can evenly be formed with high accuracy.

Further, according to the present embodiment, since the base member 43 and the heat radiation member 44 are formed separately from each other, the base member 43 and the heat radiation member 44 can be formed of respective materials different from each other. Thus, it is possible to select suitable materials to the respective members.

Further, according to the present embodiment, the axial dimension T1 of the base member main body 45 is larger than the axial dimension T3 of the heat radiation member 44. Therefore, it is easy to increase the axial dimension T1 of the base member main body 45 to be provided with the phosphor layer 42, and thus, it is easy to increase the rigidity of the base member main body 45. Thus, it is possible to prevent the warpage from causing in the base member main body 45, and it is possible to more surely prevent the phosphor layer 42 from being damaged.

Further, according to the present embodiment, apart of the heat radiation member 44 overlaps the flange part 46 of the base member 43 in the axial direction. Therefore, it is easy to increase the contact area between the heat radiation member 44 and the base member 43.

Thus, it is easy to transfer the heat of the phosphor layer 42 from the base member 43 to the heat radiation member 44. Therefore, the heat of the phosphor layer 42 can efficiently be radiated, and it is possible to more surely prevent the phosphor layer 42 from becoming high in temperature to be deteriorated. Further, since the contact area between the heat radiation member 44 and the base member 43 can be made large, it is easy to stably fix the base member 43 and the heat radiation member 44 to each other.

Further, according to the present embodiment, since the base member 43 and the heat radiation member 44 are made of metal, the heat of the phosphor layer 42 is easily transmitted through the base member 43 and the heat radiation member 44, and thus, it is possible to more efficiently radiate the heat of the phosphor layer 42.

Further, according to the present embodiment, the heat radiation member 44 and the flange part 46 have contact with each other via the thermal grease 60. Therefore, the heat is easily transferred from the flange part 46 to the heat radiation member 44 via the thermal grease 60. Thus, the heat of the phosphor layer 42 can more efficiently be radiated, and it is possible to more surely prevent the phosphor layer 42 from becoming high in temperature to be deteriorated.

It should be noted that in the present embodiment, it is also possible to adopt the following configurations.

Although in the above description, there is adopted the configuration in which the base member 43 and the heat radiation member 44 are fixed to each other with the screws 56, but the invention is not limited to this configuration. The base member 43 and the heat radiation member 44 can also be fixed to each other with rivets, or fixed to each other by welding, or fixed to each other with an adhesive. In the case of fixing the base member 43 and the heat radiation member 44 to each other with an adhesive, the type of the adhesive is not particularly limited, but can be a light curing adhesive, or can also be a thermosetting adhesive. The adhesive for fixing the base member 43 and the heat radiation member 44 to each other can be an adhesive having substantially the same composition as that of the adhesive for fixing the phosphor layer 42 to the base member 43, or can also be an adhesive having different composition.

Further, the axial dimension T2 of the flange part 46 can be equal to the axial dimension T3 of the heat radiation member 44, or can also be smaller than the dimension T3. Further, the flange part 46 is not required to be disposed.

Further, the heat radiation member 44 can be fixed to, for example, the lower surface 46b of the flange part 46, or can also be fixed to the lower surface 45b of the base member main body 45, or can also be fixed to the upper surface 45a of the base member main body 45. Further, the heat radiation member 44 is not required to have the annular shape as long as the heat radiation member 44 has a ring-like shape surrounding the central axis J. The heat radiation member 44 can also have a rectangular ring-like shape, can also have an elliptical ring-like shape.

### Second Embodiment

A second embodiment is different from the first embodiment in the point that a hole is provided to the base member. It should be noted that the constituents substantially the same as those of the embodiment described above are arbitrarily denoted by the same reference symbols, and the explanation thereof will be omitted in some cases.

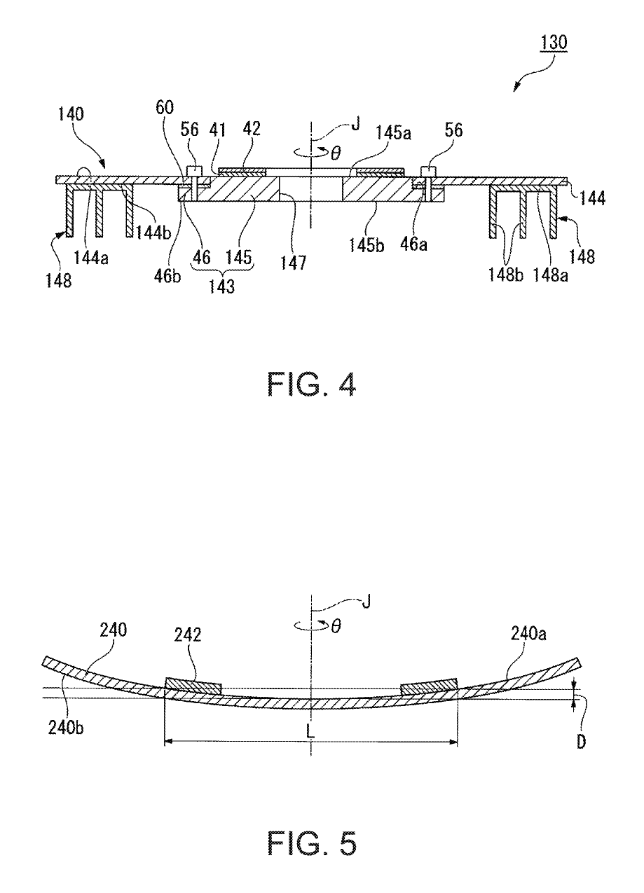

FIG. 4 is a cross-sectional view showing a region of a wavelength conversion device 130. In FIG. 4, the electric motor 50 is omitted from the drawing. As shown in FIG. 4, the wavelength conversion device 130 is provided with a base member 143, the reflecting film 41, the phosphor layer 42, and a heat radiation member 140. The base member 143 has a base member main body 145 and the flange part 46.

The base member main body 145 is provided with a hole 147 formed along the axial direction. The hole 147 opens on both of the upper surface 145a of the base member main body 145 and the lower surface 145b of the base member main body 145. In other words, in the present embodiment, the hole 147 penetrates the base member main body 145 (the base member 143) in the axial direction. The hole 147 is located on the inner side in the radial direction of the phosphor layer 42.

The outer shape of the hole 147 viewed along the axial direction is not particularly limited, but can be a circular shape or can also be a polygonal shape. In the present embodiment, the outer shape of the hole 147 viewed along the axial direction is, for example, a circular shape, the center of which the central axis J passes through. It is preferable for the shape of the hole 147 to be a shape having revolution symmetry around the central axis J. This is because it is easy to dispose the centroid of the base member 143 provided with the hole 147 on the central axis J, and it is possible to stably rotate the base member 143 around the central axis J (in the ±θ directions).

The heat radiation member 140 has a heat radiation member main body 144 and heatsinks 148. The configuration of the heat radiation member main body 144 is substantially the same as the configuration of the heat radiation member 44 of the first embodiment. The heatsinks 148 are fixed to the outer edge in the radial direction on the lower surface 144b of the heat radiation member main body 144. There is disposed a plurality of heatsinks 148. Although not shown in the drawings, the plurality of heatsinks 148 is arranged at regular intervals along the circumferential direction. In the present embodiment, the heatsinks 148 are each formed of a base part 148a to be fixed to the lower surface 144b of the heat radiation member main body 144, and a plurality of fins 148b extending downward from the base part 148a.

According to the present embodiment, since the base member main body 145 is provided with the hole 147, the weight of the base member 143 can be made lighter. Therefore, it is easy to miniaturize the electric motor 50 for rotating the base member 143, and it is easy to rotate the base member 143. Further, the drive power of the electric motor 50 can further be reduced, and the further reduction of the power consumption of the electric motor 50 can be achieved.

Further, according to the present embodiment, the hole 147 opens on the lower surface 145b of the base member main body 145. Therefore, it is possible to adopt a method of fitting the shaft 50a, or a hub or the like attached to the shaft 50a of the electric motor 50 into the hole 147 to thereby fix the base member 143 to the shaft 50a. Thus, by forming the hole 147 centered on the central axis J, the alignment of the base member 143 when attaching the base member 143 to the electric motor 50 can be simplified.

Further, according to the present embodiment, the heat radiation member 140 has the heatsinks 148. Therefore, it is easy to radiate the heat of the phosphor layer 42 using the heat radiation member 140.

It should be noted that in the present embodiment, it is also possible to adopt the following configurations.

The hole 147 is not required to penetrate the base member 143 in the axial direction. In this case, the hole 147 can be a bottomed hole recessed downward from the upper surface 145a of the base member main body 145, or can also be a bottomed hole recessed upward from the lower surface 145b of the base member main body 145. For example, in the case in which the hole 147 is the bottomed hole recessed upward from the lower surface 145b of the base member main body 145, it is also possible for the hole 147 to be formed in a region axially overlapping the phosphor layer 42.

Further, the hole 147 can also be provided to the flange part 46. Further, the number of the holes 147 is not limited to one, but can also be equal to or larger than two. In the case of forming the two or more holes 147, it is preferable for the plurality of holes 147 to be formed around the central axis J so as to have revolution symmetry. Thus, it is possible to stably rotate the base member 143 around the central axis J.

Further, the heatsinks 148 can also be fixed to the upper surface 144a of the heat radiation member main body 144.

It should be noted that although in each of the embodiments described above, there is described an example of the case in which the invention is applied to the transmissive projector, the invention can also be applied to a reflective projector. Here, “transmissive” denotes that the liquid crystal light modulation device including the liquid crystal panel and so on is a type of transmitting the light. Further, “reflective” denotes that the liquid crystal light modulation device is a type of reflecting the light.

Further, although in each of the embodiments described above, there is illustrated the projector 1 provided with the three liquid crystal light modulation devices 400R, 400G, and 400B, the invention can also be applied to a projector for displaying a color picture with a single liquid crystal light modulation device, or a projector for displaying a color image with four or more liquid crystal light modulation devices. Further, a digital mirror device (DMD) can also be used as the light modulation device. Further, a wavelength conversion element using a quantum rod can also be used as the wavelength conversion element. Further, a transmissive wavelength conversion device can also be used as the wavelength conversion device.

Further, the configurations described hereinabove can arbitrarily be combined with each other within a range in which the configurations do not conflict with each other.

What is claimed is:

1. A wavelength conversion device comprising:
a rotary device having a rotary part rotating around an axis;
a base member rotated around the axis by the rotary device;
an inorganic wavelength conversion element provided to the base member; and
a heat radiation member fixed to the base member,
wherein the heat radiation member has a ring-like shape surrounding the axis, and spreads outward in a radial direction of the axis beyond the base member, and
the heat radiation member and the base member are formed separately from each other.

2. The wavelength conversion device according to claim 1, wherein
a dimension in a direction of the axis of the base member is larger than a dimension in the direction of the axis of the heat radiation member.

3. The wavelength conversion device according to claim 1, wherein
in a case of being viewed along the direction of the axis, the base member and the heat radiation member partially overlap each other.

4. The wavelength conversion device according to claim 1, wherein
the base member is provided with a hole formed along the direction of the axis.

5. An illumination device comprising:
a light source; and
the wavelength conversion device according to claim 1,
wherein light emitted from the light source enters the wavelength conversion device, and
the wavelength conversion device performs wavelength conversion on the light having entered the wavelength conversion device using the inorganic wavelength conversion element, and emits the light, on which the wavelength conversion has been performed, on a same side as a side which the light has entered.

6. An illumination device comprising:
a light source; and
the wavelength conversion device according to claim 2,
wherein light emitted from the light source enters the wavelength conversion device, and
the wavelength conversion device performs wavelength conversion on the light having entered the wavelength conversion device using the inorganic wavelength conversion element, and emits the light, on which the wavelength conversion has been performed, on a same side as a side which the light has entered.

7. An illumination device comprising:
a light source; and
the wavelength conversion device according to claim 3,
wherein light emitted from the light source enters the wavelength conversion device, and
the wavelength conversion device performs wavelength conversion on the light having entered the wavelength conversion device using the inorganic wavelength conversion element, and emits the light, on which the wavelength conversion has been performed, on a same side as a side which the light has entered.

8. An illumination device comprising:
a light source; and
the wavelength conversion device according to claim 4,
wherein light emitted from the light source enters the wavelength conversion device, and
the wavelength conversion device performs wavelength conversion on the light having entered the wavelength conversion device using the inorganic wavelength conversion element, and emits the light, on which the wavelength conversion has been performed, on a same side as a side which the light has entered.

9. A projector comprising:
the illumination device according to claim 5;
a light modulation device adapted to modulate illumination light from the illumination device in accordance with image information to thereby form image light; and
a projection optical system adapted to project the image light.

10. A projector comprising:
the illumination device according to claim 6;
a light modulation device adapted to modulate illumination light from the illumination device in accordance with image information to thereby form image light; and
a projection optical system adapted to project the image light.

11. A projector comprising:
the illumination device according to claim 7;
a light modulation device adapted to modulate illumination light from the illumination device in accordance with image information to thereby form image light; and
a projection optical system adapted to project the image light.

12. A projector comprising:
the illumination device according to claim 8;
a light modulation device adapted to modulate illumination light from the illumination device in accordance with image information to thereby form image light; and
a projection optical system adapted to project the image light.
